(19) United States
(12) Patent Application Publication
(10) Pub. No.: US 2014/0187676 A1
(43) Pub. Date: Jul. 3, 2014

(54) EPOXY RESIN COMPOSITION FOR SEALING GEOMAGNETIC SENSOR MODULE, AND GEOMAGNETIC SENSOR MODULE SEALED WITH THE COMPOSITION

(71) Applicant: SAMSUNG ELECTRO-MECHANICS CO., LTD., Suwon (KR)

(72) Inventors: Sung Ho Lee, Suwon (KR); Boum Seock Kim, Suwon (KR); Eun Tae Park, Suwon (KR); Se Hoon Jeong, Suwon (KR)

(73) Assignee: Samsung Electro-Mechanics Co., Ltd., Suwon (KR)

(21) Appl. No.: 13/845,047

(22) Filed: Mar. 17, 2013

(30) Foreign Application Priority Data
Dec. 28, 2012 (KR) 10-2012-0157128

(51) Int. Cl. C08K 5/01; C08K 3/30; C08K 3/10; C08K 3/28; C08K 3/38; C08K 5/053; C08K 3/32

(52) U.S. Cl. CPC C08K 5/01; C08K 5/053; C08K 3/30; C08K 3/32; C08K 3/28; C08K 3/38; C08K 3/10
USPC 523/445; 523/463; 523/456; 523/457; 523/451; 523/459; 523/458

(57) ABSTRACT

The present invention provides an epoxy resin composition for sealing a geomagnetic sensor module, including: an epoxy resin; a curing agent; and a phase change material, and provides a geomagnetic sensor module sealed with the epoxy resin composition. The present invention is advantageous in that a geomagnetic sensor can be maintained at a predetermined temperature because a sealing material including a phase change material is used.

### CROSS REFERENCE TO RELATED APPLICATION

This application claims the benefit of Korean Patent Application No. 10-2012-0157128, filed Dec. 28, 2012, entitled “Epoxy resin composition for sealing geomagnetic sensor module, and geomagnetic sensor module sealed with the composition”, which is hereby incorporated by reference in its entirety into this application.

### BACKGROUND OF THE INVENTION

1. Technical Field

The present invention relates to an epoxy resin composition for sealing a geomagnetic sensor module, and a geomagnetic sensor module sealed with the composition.

2. Description of the Related Art

Recently, with the spread of smart phones, people's daily lives have become more convenient. For example, a smart phone can exhibit various functions such as gaming, position tracking, navigation and the like, by mounting the smart phone with an acceleration sensor, a geomagnetic sensor, a gyrosensor or the like. In particular, a geomagnetic sensor mounted in a smart phone has been widely researched as a method for overcoming the disadvantages of position tracking using GPS (global positioning system).

A geomagnetic sensor indicates an azimuth direction by measuring the earth's magnetic field in the range of 0.5˜0.6 Oe. The method of indicating an azimuth direction by measuring the earth's magnetic field, which is one of micromagnetic fields, is based on an azimuth direction being indicated by measuring the triaxial components of the earth's magnetic field at a position parallel to the earth's surface. Particularly, a geomagnetic sensor for smart phones generally uses the Hall effect, and thus the geomagnetic sensor using the Hall effect can be fabricated in a small size with a simple structure.

Typical examples of geomagnetic sensors applied to an electronic compass may include a magneto-resistive (MR) sensor, a flux-gate sensor, a magneto-inductive (MI) sensor, a resonator sensor based on Lorentz force, and a Hall effect sensor. All of these sensors have been developed to satisfy the requirements of precision, resolution, miniaturization and the like and to satisfy the requirements of low cost, low power consumption and the like. Among these sensors, the Hall effect sensor is applied to an electronic compass which is most frequently mounted in a smart phone.

Meanwhile, the Hall effect is a phenomenon in which Lorentz force is applied to an electron beam by an external magnetic field to warp the electron beam, and a voltage is changed by the warped electron beam. In this case, the intensity of the external magnetic field is predicted by measuring the voltage change. In brief, a current direction is curved by the earth's magnetic field and a voltage is changed by the curved current direction, and thus the intensity of the earth magnetic field can be measured. The Hall effect sensor has disadvantages of being influenced by an external magnetic field, a temperature drift and an offset voltage.

Therefore, a geomagnetic sensor is required to be designed such that it is robust against an external magnetic field, temperature and external environment. Particularly, in relation to temperature, a commercially available geomagnetic sensor is mounted with a temperature sensor for temperature compensation. This geomagnetic sensor receives temperature data from the temperature sensor and compensates the data using complicated algorithms. Currently, many geomagnetic sensor manufacturing companies are variously making efforts to solve such a problem.

### SUMMARY OF THE INVENTION

The present inventors were able to solve the above-mentioned problem by adding a phase change material (PCM) (filler) to a composition for sealing a geomagnetic sensor module as a heat storage medium, and the present invention was completed based on this finding.

Accordingly, an object of the present invention is to provide an epoxy resin composition for sealing a geomagnetic sensor module, which can maintain a geomagnetic sensor module within the permissible temperature range by properly using changeable natural phenomena and internal heat generation characteristics.

Another object of the present invention is to provide a geomagnetic sensor module sealed with the epoxy resin composition.

In order to accomplish the above objects, a first aspect of the present invention provides an epoxy resin composition for sealing a geomagnetic sensor module, including: an epoxy resin;

a curing agent; and a phase change material.

In the epoxy resin composition, the epoxy resin may be at least one selected from the group consisting of a naphthalene-based epoxy resin, a bisphenol A epoxy resin, a phenol novolac epoxy resin, a cresol novolac epoxy resin, a rubber-modified epoxy resin, and a phosphorus-based epoxy resin.

Further, the curing agent may be at least one selected from the group consisting of an amide-based curing agent, a polyamine-based curing agent, an acid anhydride curing agent, a phenol novolac curing agent, a polymercaptan curing agent, a tertiary amine curing agent, and an imidazole curing agent.

The epoxy resin composition may further include at least one selected from the group consisting of a metal-based cure promoter, an imidazole-based cure promoter, and an amine-based cure promoter.

The phase change material may be at least one selected from the group consisting of n-paraffin, polyethylene glycol, Na₂SO₄.10H₂O, Na₂HPO₄12H₂O, Zn(NO₃)₂.6H₂O, Na₂S₃O₃.5H₂O, and Na(CH₃COO).3H₂O.

The phase change material may have a particle size of 100 nm˜100 μm.

The phase change material may have latent heat of 100˜1000 J/g.

The epoxy resin composition may include: 9˜69 wt % of the epoxy resin; 0.1˜3 wt % of the curing agent; and 30˜90 wt % of the phase change material.

The epoxy resin composition may further include at least one inorganic filler selected from the group consisting of silica, alumina, barium sulfate, talc, clay, mica powder, aluminum hydroxide, magnesium hydroxide, calcium carbonate, magnesium carbonate, magnesium oxide, boron nitride, aluminum borate, barium titanate, calcium titanate, magnesium titanate, bismuth titanate, titanium oxide, barium zirconate, and calcium zirconate.

In order to accomplish the above objects, a second aspect of the present invention provides a geomagnetic sensor module sealed with the epoxy resin composition.

In the geomagnetic sensor module, the geomagnetic sensor may be a magneto-resistive (MR) sensor, a flux-gate sensor, a magneto-inductive (MI) sensor, a resonator sensor or a Hall effect sensor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing a geomagnetic sensor module sealed with an epoxy resin composition according to the present invention;

FIG. 2 is a schematic view showing a principle for maintaining an isothermal state using the latent heat of a phase change material according to the present invention; and

FIG. 3 is a graph showing the correlation between the particle size and surface area-volume ratio of the phase change material according to the present invention.

### REFERENCE NUMERALS

100: geomagnetic sensor module

10: printed circuit board

20: geomagnetic sensor

30: ordered semiconductor

40: phase change material

50: sealing material

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

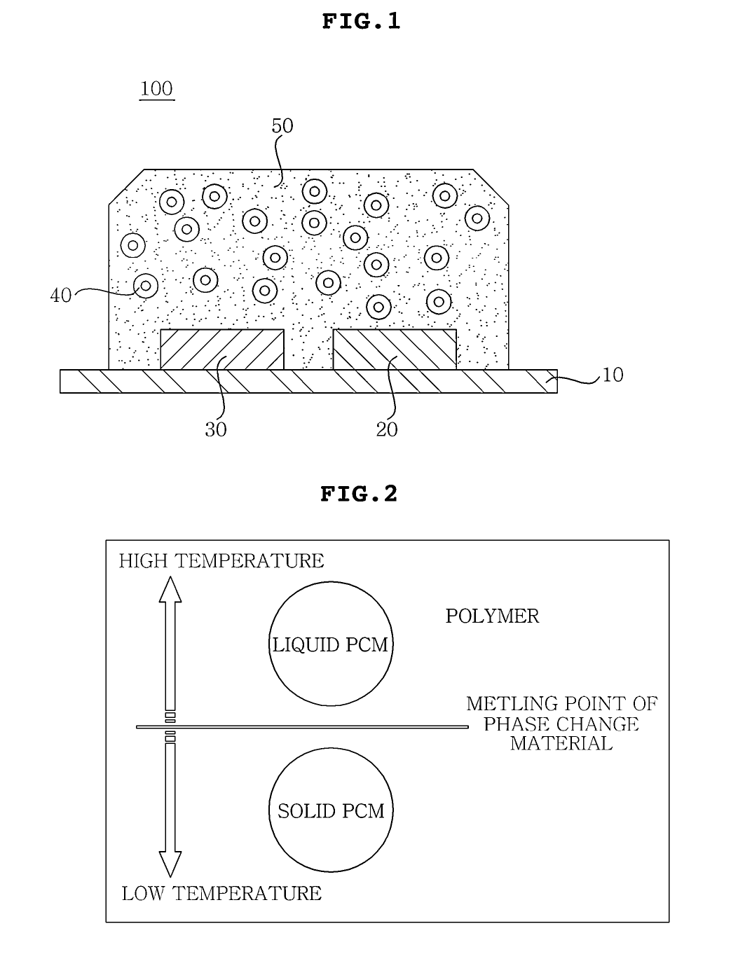

FIG. 1 is a schematic view showing a geomagnetic sensor module sealed with an epoxy resin composition according to the present invention. Referring to FIG. 1, for example, a geomagnetic sensor module 100 includes a geomagnetic sensor 20 and an ordered semiconductor 30 disposed on a printed circuit board 10. Typical examples of the geomagnetic sensor 20 may include a magneto-resistive (MR) sensor, a flux-gate sensor, a magneto-inductive (MI) sensor, a resonator sensor and a Hall effect sensor. The geomagnetic sensor 20 is provided therein with a magnetic structure, and the magnetic structure may further include other circuits. The geomagnetic sensor 20 disposed on the printed circuit board is electrically connected to the printed circuit board 10 by a standard chip-on-board technique such as wire bonding, flip chip bonding using bumps or solder balls, or the like, although it is not shown. The ordered semiconductor 30 is also electrically connected to the printed circuit board 10 by the above method.

As the geomagnetic sensor module 100 having such a structure becomes highly dense, light, thin, short and small, there a tendency to make a wiring fine and make a package small and thin. Therefore, for the purposes of processing stability, electrical insulation properties, moisture-proof properties, flame retardancy and the like, the geomagnetic sensor module 100 is sealed with a sealing material 50 including an epoxy resin.

According to the present invention, the sealing material 50 includes an epoxy resin, a curing agent and a phase change material 40. In the present invention, the temperature of the geomagnetic sensor 20 is maintained constant using the latent heat of the phase change material. The term “latent heat” means heat absorbed or radiated when any material is phase-changed, that is, when any material is changed from a solid to a liquid and from a liquid to a gas. Latent heat is much greater than heat absorbed by heating (temperature change). For instance, water absorbs heat in an amount of about 80 cal per 1 g of water when 0° C. ice is converted into 0° C. water. The amount of latent heat is the same as that of heat required to increase the temperature of water from 0° C. to 80° C. Therefore, latent heat is used to store energy or maintain a constant temperature. The material used to accomplish this purpose is referred to as “a latent heat storage material”, “phase change material” or “phase transition material”.

The epoxy resin composition according to the present invention, as described above, includes an epoxy resin in order to improve processing stability and the like. The epoxy resin is not particularly limited, but may be an epoxy resin having one or more epoxy groups in a molecule thereof, preferably an epoxy resin having two or more epoxy groups in a molecule thereof, and more preferably an epoxy resin having four or more epoxy groups in a molecule thereof.

Examples of the epoxy resin used in the present invention may include a bisphenol A epoxy resin, a bisphenol F epoxy resin, a bisphenol S epoxy resin, a phenol novolac epoxy resin, an alkylphenol novolac epoxy resin, a biphenyl epoxy resin, an aralkyl epoxy resin, a dicyclopentadiene epoxy resin, a naphthalene epoxy resin, a naphthol epoxy resin, an epoxy resin including a condensate of phenols and aromatic aldehydes having a phenolic hydroxyl group, biphenylaralkyl epoxy resin, a fluorene epoxy resin, a xanthene epoxy resin, triglycidylisocyanurate, a rubber-modified epoxy resin, and a phosphorus-based epoxy resin, preferably, a naphthalene epoxy resin, a bisphenol A epoxy resin, a phenol novolac epoxy resin, a cresol novolac epoxy resin, a rubber-modified epoxy resin, and a phosphorus-based epoxy resin. These epoxy resins may be used independently or in a mixture thereof.

The epoxy resin may be included in an amount of 9 to 69 wt %. When the amount thereof is less than 9 wt %, processability deteriorates, and when the amount thereof is more than 69 wt %, the amount of a phase change material relatively decreases, thus deteriorating temperature stability.

The epoxy resin composition according to the present invention may selectively include a curing agent in order to improve process efficiency. The curing agent may be at least one selected from the group consisting of an amide-based curing agent, a polyamine-based curing agent, an acid anhydride curing agent, a phenol novolac curing agent, a polymercaptan curing agent, a tertiary amine curing agent, and an imidazole curing agent, but is not limited thereto.

The curing agent may be included in an amount of 0.1 to 3 wt %. When the amount thereof is less than 0.1 wt %, the epoxy resin composition is not easily cured at a high temperature, and the curing speed of the epoxy resin composition decreases. Further, when the amount thereof is more than 3 wt %, there are problems in that the curing speed thereof is excessively rapid, so the process applicability thereof or the storage stability thereof deteriorates, and in that the unreacted curing agent remains after the reaction, so the hygroscopicity of an insulation film or a prepreg increases, thereby deteriorating the electrical characteristics thereof.

The epoxy resin composition of the present invention may selectively include a cure promoter in order to efficiently cure the epoxy resin composition. The cure promoter used in the present invention may be selected from a metal-based cure promoter, an imidazole-based cure promoter and an amine-based cure promoter. These cure promoters may be used independently or in a combination thereof, and may be used in a general amount commonly used in the related filed. Examples of the metal-based cure promoter may include, but are not limited to, an organic metal complex containing a metal such as cobalt, copper, zinc, iron, nickel, manganese, tin or the like, and an organic metal salt containing a metal such as cobalt, copper, zinc, iron, nickel, manganese, tin or the like. Specific examples of the organic metal complex may include: an organic cobalt complex such as cobalt (II) acetylacetonate, cobalt (III) acetylacetonate or the like; an organic copper complex such as copper (II) acetylacetonate or the like; an organic zinc complex such as zinc (II) acetylacetonate or the like; an organic iron complex such as iron (II) acetylacetonate or the like; an organic nickel complex such as nickel (II) acetylacetonate or the like; and an organic manganese complex such as manganese (II) acetylacetonate or the like. Specific examples of the organic metal salt may include zinc octylate, tin octylate, zinc naphthenate, cobalt naphthenate, tin stearate, zinc stearate and the like. In terms of solvent solubility, the metal-based cure promoter may be cobalt (II) acetylacetonate, cobalt (III) acetylacetonate, zinc (II) acetylacetonate, zinc naphthenate or iron (III) acetylacetonate, and preferably cobalt (II) acetylacetonate or zinc naphthenate. These metal-based cure promoters may be used independently or in a combination thereof.

Examples of the imidazole-based cure promoter may include, but are not particularly limited to, imidazole compounds and adducts of the imidazole compounds and epoxy resins, such as 2-methylimidazole, 2-undecylimidazole, 2-heptadecylimidazole, 1,2-dimethylimidazole, 2-ethyl-4-methylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-cyanoethyl-2-methylimidazole, 1-cyanoethyl-2-undecylimidazole, 1-cyanoethyl-2-ethyl-4-methylimidazole, 1-cyanoethyl-2-phenylimidazole, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-s-triazine, 2,4-diamino-6[2′-undecylimidazolyl-(1′)]-ethyl-s-triazine, 2,4-diamino-6-[2′-ethyl-4′-methylimidazolyl-(1′)]-ethyl-s-triazine, 2,4-diamino-6-[2′-methylimidazolyl-(1′)]-ethyl-s-triazine isocyanurate adduct, 2-phenylimidazole isocyanurate adduct, 2-phenyl-4,5-dihydroxymethylimidazole, 2-phenyl-4-methyl-5-hydroxymethylimidazole, 2,3-dihydroxy-1H-pyrrolo[1,2-a]benzimidazole, 1-dodecyl-2-methyl-3-benzylimidazolium chloride, 2-methylimidzoline, and 2-phenylimidazoline. These imidazole-based cure promoters may be used independently or in a combination thereof.

Examples of the amine-based cure promoter may include, but are not particularly limited to, amine compounds, such as a trialkylamine (triethylamine, tributylamine or the like), 4-dimethylaminopyridine, benzyldimethylamine, 2,4,6-tris(dimethylaminomethyl)phenol, and 1,8-diazabicyclo(5,4,0)-undecene (hereinafter referred to as “DBU”). These amine-based cure promoters may be used independently or in a combination thereof.

As described above, the epoxy resin composition according to the present invention includes a phase change material. The phase change material is generally referred to as “a latent heat storage material” or “a latent heat accumulation material”, and, as shown in FIG. 2, is a material that absorbs and radiates thermal energy while changing from a solid phase to a liquid phase or from a liquid phase to a solid phase. Such a phase change material exists in the state of a liquid or a solid, and its phase is reversibly changed at a predetermined temperature when it radiates heat to the outside or absorbs heat from the outside. The heat radiated or absorbed during this procedure contributes to the phase change of a material, not the temperature rise of a material, so the temperature change of a material is relatively small compared to the amount of applied heat. Therefore, only when the phase change material completely radiates latent heat during a phase change process although ambient temperature decreases, a temperature change substantially occur, thus exhibiting an adiabatic effect.

Specific examples of the phase change material may include: straight-chained saturated hydrocarbons consisting of carbon and hydrogen, such as tetradecane, octadecane, nonadecane and the like; and aliphatic or aromatic compounds, such as propionamide, naphthalene, acetamide, biphenyl, stearic acid, polyglycol, paraffin, palmitic acid, ethyl linoleate, camphane, 3-heptadecanone, cyanamide, lauric acid, caprolon and the like. Preferably, paraffin may be used as the phase change material.

Further, an inorganic compound having a hydrous form of a hydrocarbon of 13 to 28 carbon atoms may be used as the phase change material. Examples of the inorganic compound may include Fe₂O₃.4SO₃.9H₂O, NaNH₄SO₄.2H₂O, NaNH₄HPO₄.2H₂O, NaNH₄HPO₄.4H₂O, FeCl₃.2H₂O, Na₃PO₄.12H₂O, Na₂SiO₃.5H₂O, Ca(NO₃)₂.3H₂O, K₂HPO₄.3H₂O, Na₂SiO₃.9H₂O, Fe(NO₃)₃.9H₂O, K₃PO₄.7H₂O, Na₂HPO₄.12H₂O, NaHPO₄.12H₂O, Zn(NO₃)₂.6H₂O, Na₂S₃O₃.5H₂O, CaCl₂.6H₂O, Na₂SO₄.10H₂O, and Na(CH₃COO).3H₂O. Further, the phase change material may be selected from polyethylene glycol, n-octanoic acid, n-octadecane, n-eicosane, acetic acid, lactic acid, chloroacetic acid, and mixtures thereof. Typical examples of the phase change material may include paraffin, polyethylene glycol, Na₂SO₄.10H₂O, Na₂HPO₄.12H₂O, Zn(NO₃)₂.6H₂O, Na₂S₃O₃.5H₂O and Na(CH₃COO).3H₂O, and the melting points and latent heat amounts thereof are given in Table 1 below.

TABLE 1

| Phase change material | Melting point (° C.) | Latent heat (J/g) |
|---|---|---|
| n-paraffin | −5~110 | 180~220 |
| Polyethylene glycol | 10~50 | — |
| Na₂SO₄•10H₂O | 32 | 176 |
| Na₂HPO₄•12H₂O | 36 | 281 |
| Zn(NO₃)₂•6H₂O | 36.4 | 155 |
| Na₂S₃O₃•5H₂O | 48 | 201 |
| Na(CH₃COO)•3H₂O | 50 | 134 |

In the present invention, although a single pure phase change material may be used, a eutectic mixture of two or kinds of phase change materials may also be used such that the phase change accompanying high heat input and output occurs over a wide temperature range. As such, the operation temperature range of the geomagnetic sensor module can be controlled by mixing various kinds of phase change materials.

In the present invention, a phase change material having large latent heat per unit mass is advantageous. However, most of easily-obtainable phase change materials have latent heat energy of 100 to 1000 J/g, and parts of inorganic hydrous materials do not phase-change and do not radiate latent heat even when they are cooled to below the melting point thereof, thus causing a supercooling phenomenon. In order to prevent such a supercooling phenomenon, a nucleating agent may be added.

As described above, the sealing of a geomagnetic sensor module is generally performed after wire bonding in order to protect a semiconductor chip from the external environment, electrically insulate the geomagnetic sensor module, effectively radiate heat and conveniently mount the geomagnetic sensor module with a semiconductor chip. In the present invention, in addition to the above functions, the geomagnetic sensor module is packaged with a mixture of a phase change material and a sealing material, thus reducing errors of initial data of a geomagnetic sensor which is very sensitive to temperature.

For this purpose, in the present invention, the geomagnetic sensor module is filled with the phase change material in an amount of 30˜90 wt % to maintain the temperature of the module to be constant. When the amount of the phase change material is less than 30 wt %, the effect of addition is low. Further, when the amount thereof is more than 90 wt %, the content of an epoxy resin becomes relatively low, thus deteriorating the processing stability of the module.

Meanwhile, the epoxy resin composition of the present invention may further include other inorganic fillers within the range of usage of the phase change material. Specific examples of the inorganic fillers may include silica, alumina, barium sulfate, talc, clay, mica powder, aluminum hydroxide, magnesium hydroxide, calcium carbonate, magnesium carbonate, magnesium oxide, boron nitride, aluminum borate, barium titanate, calcium titanate, magnesium titanate, bismuth titanate, titanium oxide, barium zirconate, and calcium zirconate. These fillers may be used independently or in a combination thereof. Preferably, the inorganic filler may be silica having a low dielectric loss tangent.

As described above, in the present invention, the stability of a geomagnetic sensor to temperature can be improved by using the inorganic filler in addition to the phase change material. In the present invention, it is required to adjust the particle size of the phase change material in order to maximize the effect of addition of the inorganic filler. Generally, the reactivity of the phase change material is proportional to the ratio of surface area to volume thereof. Therefore, even when the same amount of an inorganic filler is added, an inorganic filler having a large particle size is not good compared to an inorganic filler having a small particle size in terms of effects. The reason for this is because the surface of the phase change material is composed of dangling bonds. Therefore, the particle size of the phase change material is adjusted to 100 nm˜100 μm.

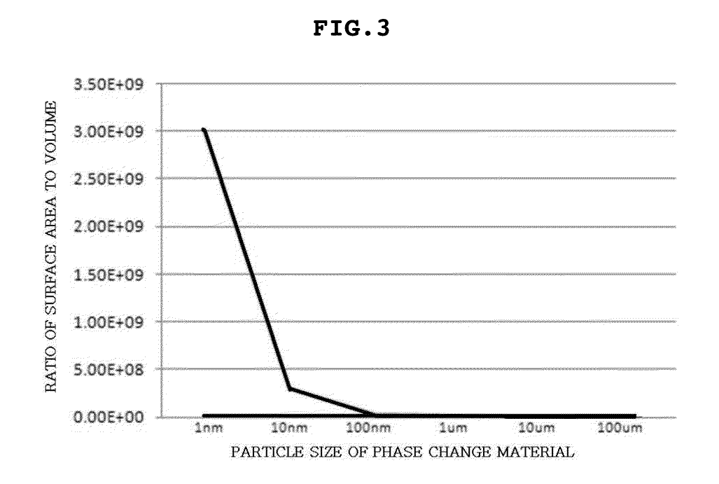

FIG. 3 shows the correlation between the particle size and surface area-volume ratio of the phase change material. As shown in FIG. 3, with the decrease of the particle size of the phase change material, the ratio of surface area to volume thereof rapidly increases. This fact means that the temperature stability to latent heat can be maximized even though a small amount of phase change material is used. However, even when the particle size of the phase change material is adjusted to 1 nm˜100 nm in order to maximize the temperature stability to latent heat, the dispersibility of the phase change material may be deteriorated in an actual process. Therefore, it is preferred that the particle size of the phase change material be 100 nm˜100 μm.

As described above, the present invention is advantageous in that a geomagnetic sensor can be maintained at a predetermined temperature with respect to an external temperature change because a sealing material including a phase change material is used. Further, the present invention is advantageous in that the temperature range to be designed can be controlled using various phase change materials. As a result, since the temperature is maintained constant, the output value of the geomagnetic sensor according to temperature change can be maintained constant, so accurate data can be obtained, thereby accurately recognizing a position. Further, since temperature compensation is not needed, the compensation of algorithm and S/W is not required, so a geomagnetic sensor is advantageous in terms of speed. Further, since conditioning temperature and humidity can be controlled without using an external power source when a phase change material is used, power consumption necessary for operating a temperature sensor can be reduced. Further, since the heat storage and radiation technology using the present invention can maintain a geomagnetic sensor module within the permissible temperature range by properly using changeable natural phenomena and internal heat generation characteristics, there are advantageous in that heat and Freon gas are not generated because a machine or apparatus is not used to cool the geomagnetic sensor module, in that the geomagnetic sensor module can be easily repaired and maintained because driving parts may not be replaced and in that the geomagnetic sensor module does not make noise.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An epoxy resin composition for sealing a geomagnetic sensor module, comprising: an epoxy resin; a curing agent; and a phase change material.

2. The epoxy resin composition of claim 1, wherein the epoxy resin is at least one selected from the group consisting of a naphthalene-based epoxy resin, a bisphenol A epoxy resin, a phenol novolac epoxy resin, a cresol novolac epoxy resin, a rubber-modified epoxy resin, and a phosphorus-based epoxy resin.

3. The epoxy resin composition of claim 1, wherein the curing agent is at least one selected from the group consisting of an amide-based curing agent, a polyamine-based curing agent, an acid anhydride curing agent, a phenol novolac curing agent, a polymercaptan curing agent, a tertiary amine curing agent, and an imidazole curing agent.

4. The epoxy resin composition of claim 3, further comprising at least one selected from the group consisting of a metal-based cure promoter, an imidazole-based cure promoter, and an amine-based cure promoter.

5. The epoxy resin composition of claim 1, wherein the phase change material is at least one selected from the group consisting of n-paraffin, polyethylene glycol, Na₂SO₄.10H₂O, Na₂HPO₄.12H₂O, Zn(NO₃)₂.6H₂O, Na₂S₃O₃.5H₂O, and Na(CH₃COO).3H₂O.

6. The epoxy resin composition of claim 5, wherein the phase change material has a particle size of 100 nm˜100 μm.

7. The epoxy resin composition of claim 1, wherein the phase change material has latent heat of 100˜1000 J/g.

8. The epoxy resin composition of claim 1, wherein the epoxy resin composition comprises: 9˜69 wt % of the epoxy resin; 0.1˜3 wt % of the curing agent; and 30˜90 wt % of the phase change material.

9. The epoxy resin composition of claim 1, further comprising at least one inorganic filler selected from the group consisting of silica, alumina, barium sulfate, talc, clay, mica powder, aluminum hydroxide, magnesium hydroxide, calcium carbonate, magnesium carbonate, magnesium oxide, boron nitride, aluminum borate, barium titanate, calcium titanate, magnesium titanate, bismuth titanate, titanium oxide, barium zirconate, and calcium zirconate.

10. A geomagnetic sensor module sealed with the epoxy resin composition of claim 1.

11. A geomagnetic sensor module sealed with the epoxy resin composition of claim 2.

12. A geomagnetic sensor module sealed with the epoxy resin composition of claim 3.

13. A geomagnetic sensor module sealed with the epoxy resin composition of claim 4.

14. A geomagnetic sensor module sealed with the epoxy resin composition of claim 5.

15. A geomagnetic sensor module sealed with the epoxy resin composition of claim 6.

16. A geomagnetic sensor module sealed with the epoxy resin composition of claim 7.

17. A geomagnetic sensor module sealed with the epoxy resin composition of claim 8.

18. A geomagnetic sensor module sealed with the epoxy resin composition of claim 9.

19. The geomagnetic sensor module of claim 10, wherein the geomagnetic sensor is a magneto-resistive (MR) sensor, a flux-gate sensor, a magneto-inductive (MI) sensor, a resonator sensor or a Hall effect sensor.
